(19) United States
(12) Patent Application Publication
(10) Pub. No.: US 2003/0235378 A1
(43) Pub. Date: Dec. 25, 2003

(54) Optical transmitter/receiver module

(76) Inventor: Takahiro Yamaguchi, Tokyo (JP)

Correspondence Address: KANESAKA &TAKEUCHI, 1423 Powhatan Street, Alexandria, VA, 22314, US

(21) Appl. No.: 10/463,471

(22) Filed: Jun. 18, 2003

(30) Foreign Application Priority Data
Jun. 25, 2002 (JP) 2002-184664

(51) Int. Cl. G02B 6/42

(52) U.S. Cl. 385/92

(57) ABSTRACT

An optical transmitter/receiver module comprises a package (22), a silicon substrate (24) having an optical transmitter section (12) with an optical source to convert an electrical signal to an optical signal and an optical fiber (16) to transmit the optical signal, a silicon substrate (26) having an optical receiver section (18) with an optical detector to convert the optical signal to the electrical signal on an upper surface thereof, and a WDM optical circuit (14) provided between the silicon substrates (24 and 26) and supplying the optical signal from the optical transmitter section (12) to the optical fiber (16) and the optical signal from the optical fiber (16) to the optical receiver section (18). The module further comprises a metal wire (32) provided over the optical receiver section (18) and having ends fixed and grounded to the package (22).

### BACKGROUND OF THE INVENTION

1. Field of the Invention

This invention relates to an optical transmitter/receiver module capable of reducing an electrical noise in an optical receiver section with an optical detector device, which is caused by electromagnetic waves emitted from an optical transmitter section with an optical source device.

2. Description of the Related Art

Recently, an asynchronous transfer mode based passing optical network (ATM-PON) system has been attracting a public attention as one of the networks which connect a plurality of subscribers and a station by optical fibers because it provides a low-cost and high-speed service. An optical transmitter/receiver module used by a subscriber receives an optical signal of 1.5 μm band from an optical fiber with the optical detector device of the optical receiver section, and transmits an optical signal of 1.3 μm band through the optical fiber, which is emitted by the optical source device of the optical transmitter section, thus providing a two-way communication. The optical source and detector devices are normally accommodated in the same package.

However, in the above conventional optical transmitter/receiver module, the optical transmitter and receiver sections are disposed so closely to each other that when both the sections simultaneously operate, an electrical noise caused in the optical receiver section by the electrical cross talk between the optical receiver and transmitter sections, reduces the minimum photo detecting sensitivity of the optical receiver section. If the optical transmitter and receiver sections are disposed at a remote distance for reducing the electrical cross talk, it is difficult to reduce the size of the optical transmitter and receiver module.

### SUMMARY OF THE INVENTION

Accordingly, an object of the invention is to provide an optical transmitter and receiver module capable of reducing the electrical cross talk without increasing the distance between the optical transmitter and receiver sections.

According to one aspect of the invention, there is provided an optical transmitter/receiver module which comprises a package having an inside wall and a ground portion, an optical transmitter section provided in the package and having an optical source to convert an electrical signal to an optical signal, an optical receiver section provided in the package and having an optical detector to convert the optical signal to the electrical signal, and a metal wire provided over the optical transmitter or receiver section and having ends fixed to the inside wall of the package and connected to the ground portion of the package.

According to another aspect of the invention, an optical transmitter/receiver module comprises two metal wires; a first metal wire provided over the optical transmitter section and having ends which are fixed to the inside wall of the package and connected to the ground portion of the package, and a second metal wire provided over the optical receiver section and having ends fixed to the inside wall of the package and connected to the ground portion of the package.

According to still another aspect of the invention, an optical transmitter/receiver module comprises a plurality of metal wires provided in parallel to each other at a predetermined interval such that they pass over the optical transmitter and receiver sections, each metal wire having ends fixed to the inside wall of the package and connected to the ground portion of the package.

According to yet another aspect of the invention, an optical transmitter/receiver module comprises a metal plate covering the optical transmitter or receiver section and having an end fixed to the inside bottom of the package and connected to the ground portion of the package.

According to one aspect of the invention, an optical transmitter/receiver module comprises first and second metal plates covering over the optical transmitter and receiver sections, respectively, each metal plate having an end which is fixed to the inside bottom of the package and connected to the ground portion of the package.

According to another aspect of the invention, an optical transmitter/receiver module comprises a metal plate covering the optical transmitter and receiver sections and having ends bent in the same direction so as to be fixed to the inside bottom of the package and connected to the ground portion of the package.

According to still another aspect of the invention, an optical transmitter/receiver module comprises an electromagnetic wave absorbing member provided -in the vicinity of the optical transmitter section or the optical receiver section and having an end fixed to the inside bottom of the package.

According to yet another aspect of the invention, an optical transmitter/receiver module comprises first and second electromagnetic wave absorbing members provided in the vicinity of the optical transmitter section and the optical receiver section, respectively, and each absorbing member having an end fixed to the inside bottom of the package.

According to one aspect of the invention, an optical transmitter/receiver module comprises an electromagnetic wave absorbing member provided in the package so as to cover the optical transmitter and receiver sections.

### BRIEF DESCRIPTION OF THE DRAWINGS

FIG. 1 is a block diagram of an optical transmitter/receiver module according to the invention.

FIG. 2 is a perspective view of the optical transmitter/receiver module of FIG. 1.

FIG. 3 is a top plan view of an optical transmitter/receiver module according to the first embodiment of the invention.

FIG. 4 is a sectional view taken along line 4-4 of FIG. 3.

FIG. 5 is a top plan view of an optical transmitter/receiver module according to the second embodiment of the invention.

FIG. 6 is a sectional view taken along line 6-6 of FIG. 5.

FIG. 7 is a top plan view of an optical transmitter/receiver module according to the fourth embodiment of the invention.

FIG. 8 is a sectional view of the optical transmitter/receiver module of FIG. 7 taken along the line 8-8.

FIG. 9 is a top plan view of an optical transmitter/receiver module according to the fifth embodiment of the invention.

FIG. 10 is a sectional view taken along line 10-10 of FIG. 9.

FIG. 11 is a top plan view of an optical transmitter/receiver module according to the sixth embodiment of the invention.

FIG. 12 is a sectional view taken along line 1212 of FIG. 11.

FIG. 13 is a top plan view of an optical transmitter/receiver module according to the eighth embodiment of the invention.

FIG. 14 is a sectional view taken along line 14-14 of FIG. 13.

FIG. 15 is a top plan view of an optical transmitter/receiver module according to the ninth embodiment of the invention.

FIG. 16 is a sectional view taken along line 1616 of FIG. 15.

FIG. 17 is a top plan view of an optical transmitter/receiver module according to the tenth embodiment of the invention.

FIG. 18 is a sectional view taken along line 1818 of FIG. 17.

FIG. 19 is a top plan view of an optical transmitter/receiver module according to the twelfth embodiment of the invention.

### DESCRIPTION OF THE PREFERRED EMBODIMENT

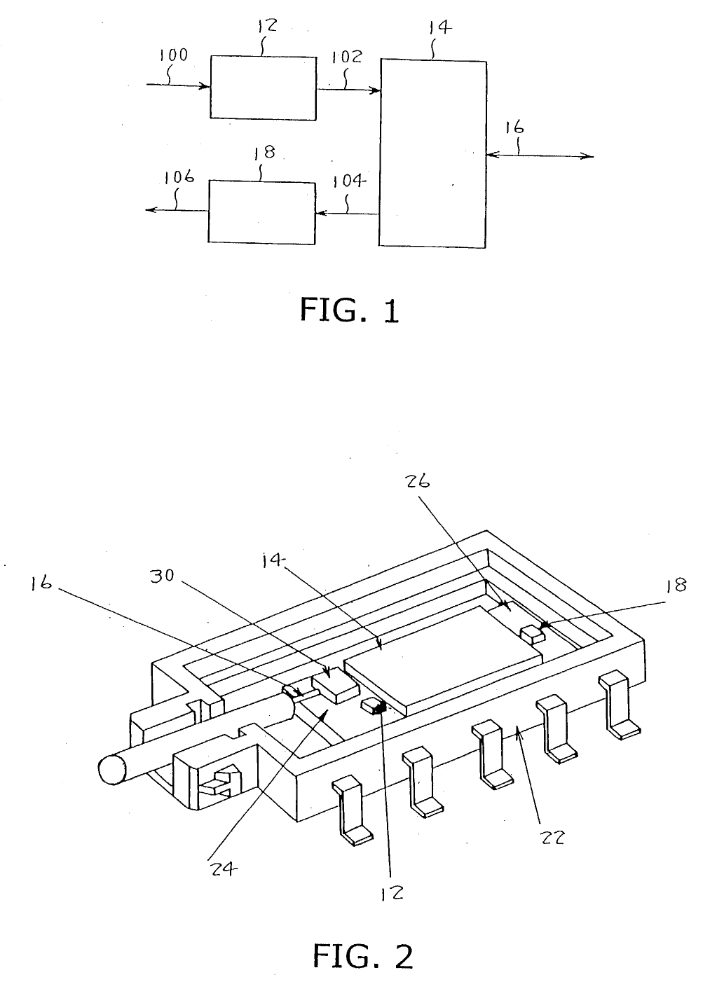

Embodiments of the invention will now be described with reference to the accompanying drawings. In FIG. 1, an optical transmitter/receiver module according to the invention is composed of an optical transmitter section 12, a wavelength division multiplex (WDM) optical circuit section 14, an optical fiber 16, and an optical receiver section 18.

The optical transmitter section 12 includes an optical source device, such as a laser diode (LD), and transmits an optical signal 102 of 1.3 μm band which is modulated by an input signal 100. The WDM optical circuit 14 multiplexes and demultiplexes optical signals of 1.3 μm band and 1.5 μm band by having a WDM filter inserted or using an optical wave path adhered to the end face thereof. The WDM optical circuit 14 reflects the optical signal 102 of 1.3 μm band supplied from the optical transmitter section 12 by the WDM filter and sends it to the optical fiber 16, and sends the optical signal of 1.5 μm band supplied from the optical fiber 16 to the optical receiver section 18 through the WDM filter as an optical signal 104.

The optical fiber 16 is an optical transmission path to connect subscribers and a station, which transmits the optical signal of 1.3 μm band from the subscribers to the station and the optical signal of 1.5 μm band from the station to the subscribers. The optical receiver section 18 converts the optical signal 104 supplied from the WDM optical circuit 14 to an electrical signal by an optical detector device, such as photo diode (PD), amplified it up to a predetermined level by a head amplifier, and outputs it as a signal 106.

The operation of the optical transmitter/receiver module will be described briefly. The 1.5 μm band optical signal supplied from the optical fiber 16 is input to the WDM optical circuit 14 and sent to the optical receiver section 18 through the WDM filter of the WDM optical circuit 14 as the optical signal 104. Then, it is converted to an electrical signal by the photo diode (PD) of the optical receiver section 18 and sent as the signal 106. The signal 100 input to the optical transmitter section 12 is converted to the 1.3 μm band optical signal 102 by the laser diode (LD) and sent to the WDM optical circuit 14. Then, it is reflected by the WDM filter of the WDM optical circuit 14 and sent to the optical fiber 16.

In FIG. 2, reference number 22 is an insulative flat-mount type package made of an epoxy resin, and comprises an opening for receiving the optical fiber and a plurality of terminals to be connected to an external circuit. Silicon substrates 24 and 26 are provided on the interior bottom of the package 22 at a predetermined distance. The silicon substrates 24 and 26 are adhered to the interior bottom by a resin 28 (not shown).

The optical transmitter section 12 including the semiconductor laser (LD) for converting an electrical signal into an optical signal and the front end of the optical fiber 16 are mounted and fixed on the upper surface of the silicon substrate 24 at predetermined positions. The optical receiver section 18 including the photo diode (PD) for converting an optical signal to an electrical signal is mounted and fixed to the upper surface of the silicon substrate 26 at a predetermined position. The WDM optical circuit 14, which is made by forming an optical wave path on a quartz substrate, is fixed between the silicon substrates 24 and 26.

The optical transmitter section 12, WDM optical circuit 14, and optical receiver section 18 are fixed to the silicon substrates 24 and 26 by a flip-chip-dice bonder or the like after markers are precisely formed in an LD active layer of the optical transmitter section 12, the optical wave path of the WDM optical circuit 14, and a PD photo detective layer of the optical receiver section 18, respectively, and aligned with, at the accuracy of a sub-micron order, V-shaped grooves having “V” cross sectional shapes, which are precisely formed by etching on the upper surfaces of the silicon substrates 24 and 26.

The top portion of optical fiber 16 is mounted in a V-shaped groove precisely formed by etching on the upper surface of the silicon substrate 24 at a predetermined position and fixed on the V-shaped groove by UV adhesion. At this point, the top portion is pressed by a pressing plate 30 such that it is not lifted from the V-shaped groove. The pressing plate is also fixed on the V-shaped groove by the UV adhesive. A cap made of a resin is bonded on the package 22 at the final stage.

In addition, the optical transmitter/receiver module in FIG. 2 is provided with an electrical noise preventive measure to reduce the electrical cross talk between the optical transmitter section 12 and the optical receiver section 18 so that the electrical noise in the optical receiver section 18 is reduced.

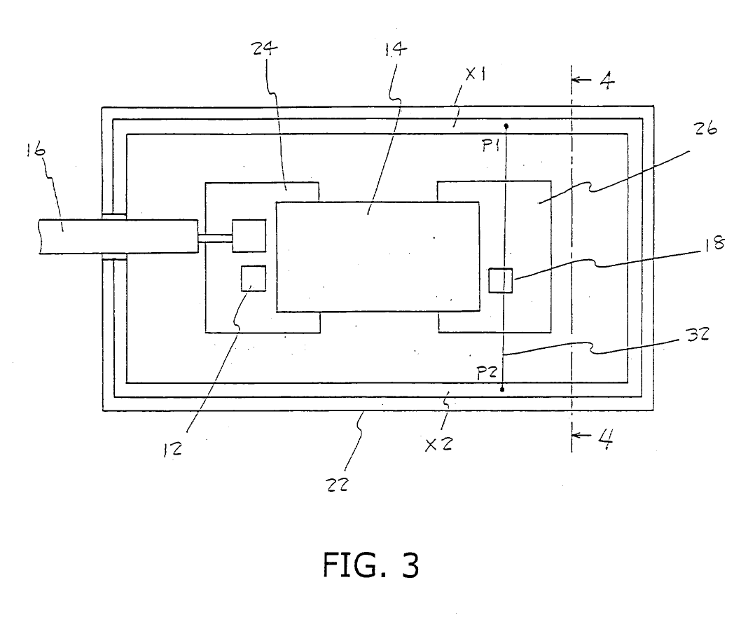

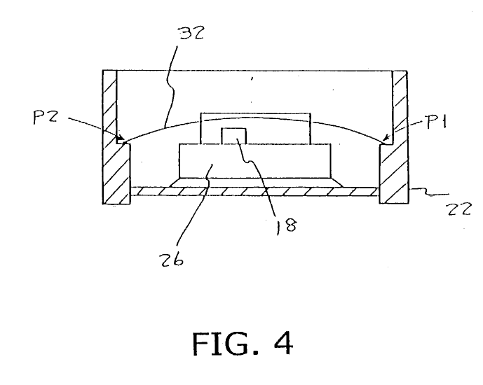

In FIGS. 3 and 4, the optical transmitter/receiver module with the electrical noise preventive measure according to the first embodiment comprises a conductive wire, such as a metal wire 32 made of gold and having a diameter of25 μm, which is connected between points P1 and P2 on flat portions X1 and X2 formed on the inside walls of the package 22 such that the metal wire 32 crosses over the optical receiver section 18 mounted on the silicon substrate 26. The ends of the metal wire 32 are not only bonded to the points P1 and P2 but also connected to a ground portion (GND) provided on the interior bottom of the package 22. Accordingly, electromagnetic wave input to the optical receiver section 18 is weakened by the metal wire 32 so that the electrical cross talk from the optical transmitter section 12 to the optical receiver section 18 is reduced and the electrical noise in the optical receiver section 18 is reduced.

Experiments showed that when the photo output of the laser diode (LD) of the optical transmitter section 12 is 10 DBMS (minimum), photo detective sensitivity of the photo diode (PD) in the optical receiver section 18 is 0.8 A/W (minimum), the distance between the optical transmitter and receiver sections 12 and 18 is 5 mm, and the signal speed of transmitted signal (data) during the operation of the laser diode (LD) is 622.08 MHz, the minimum photo detective sensibility of the optical receiver section 18 during the operation of the laser diode (LD) was −28 dBm. The value meets the requirements under ITU-TG983.1 Class B. When the metal wire 32 was not provided, the minimum photo detective sensitivity was −26 dbms. Thus, the minimum photo detective sensitivity was increased by 3 dBm by providing the metal wire 32.

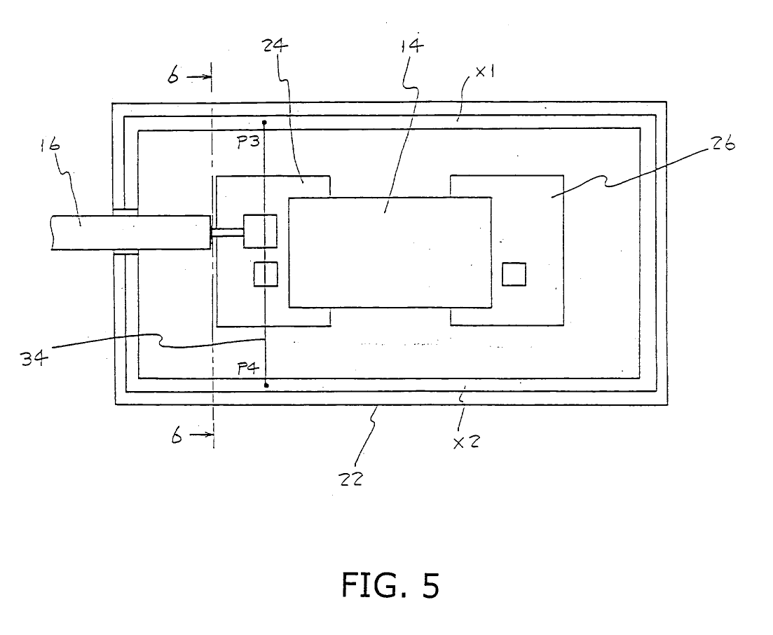

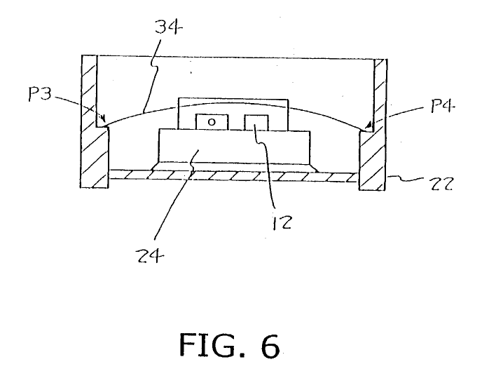

In FIGS. 5 and 6, the optical transmitter/receiver module with the electrical noise preventive measure according to the second embodiment comprises a conductive wire, such as a metal wire 34 made of gold and having a diameter of 25 μm, which is connected between points P3 and P4 on flat portions X1 and X2 formed on the inside walls of the package 22 such that the metal wire 32 passes over the optical transmitter section 12 mounted on the silicon substrate 24. The ends of the metal wire 32 are not only bonded to the points P3 and P4 but also connected to a ground portion (GND) provided on the interior bottom of the package 22. According to the second embodiment, the same effects as those in the first embodiment are obtained.

In the optical transmitter/receiver module with the electrical noise preventive measure according to the third embodiment, the metal wire 32 passes over the optical receiver section 18 mounted on the silicon substrate 26 in the same way as that in the first embodiment and the metal wire 34 passes over the optical transmitter section 12 mounted on the silicon substrate 24 in the same way as that in the second embodiment. According to the third embodiment, the same effects as those in the first embodiment are obtained.

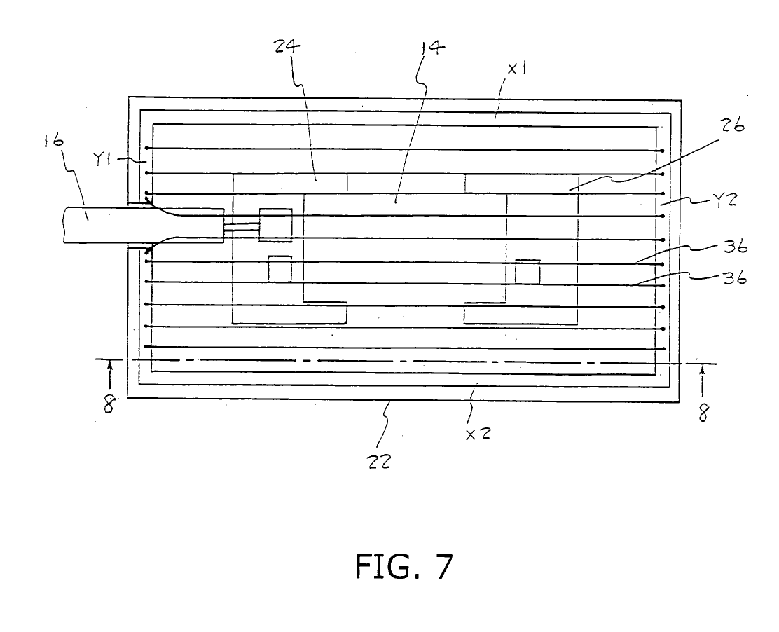

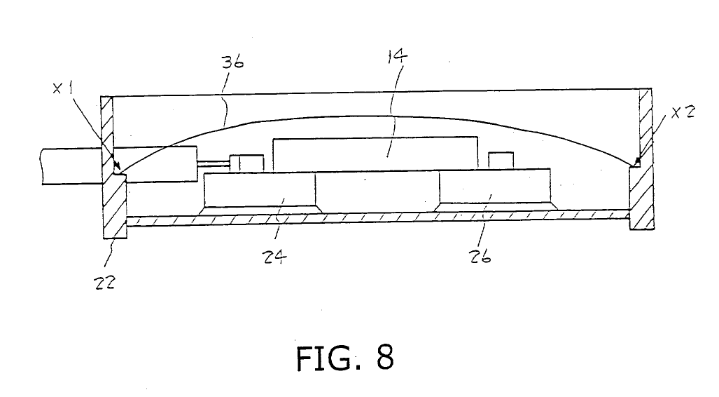

In FIGS. 7 and 8, the optical transmitter/receiver module with the electrical noise preventive measure according to the fourth embodiment comprises a plurality of metal wires 36 which pass over the optical transmitter section 12, the WDM optical circuit 14, and the optical receiver section 18. That is, a plurality of the metal wires 36 having a diameter of 25 μmare connected between flat portions Y1 and Y2 formed on the inside walls of the package 22 at an interval of 500 μm such that the metal wires pass over the whole parts in the package 22. The respective ends of the metal wires 36 are connected to the ground portion (GND) provided on the interior bottom of the package 22. According to the fourth embodiment, the same effects as those in the first embodiment are obtained.

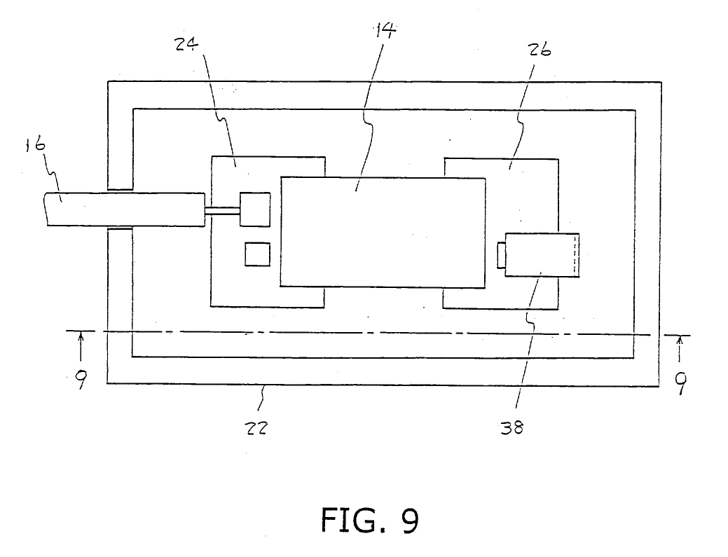

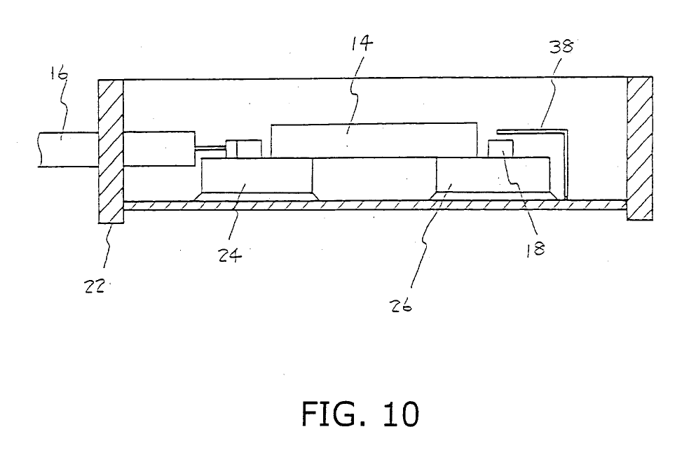

In FIGS. 9 and 10, the optical transmitter/receiver module with the electrical noise preventive measure according to the fifth embodiment comprises an L-shaped metal plate, such as a metal plate 38 made of a Copper-Nickel alloy and having a width of approximately 2.35 mm, which is bonded on the interior bottom of the package 22 in the vicinity of the optical receiver section 18 such that an end of the metal plate 38 covers the upper surface of the optical receiver section 18 on the silicon substrate 26. The metal plate 38 is connected to the ground portion (GND) provided on the interior bottom of the package 22. Accordingly to the fifth embodiment, the same effects as those in the first embodiment are obtained because the major part of electromagnetic wave input to the optical receiver section 18 is shielded by the metal plate 38.

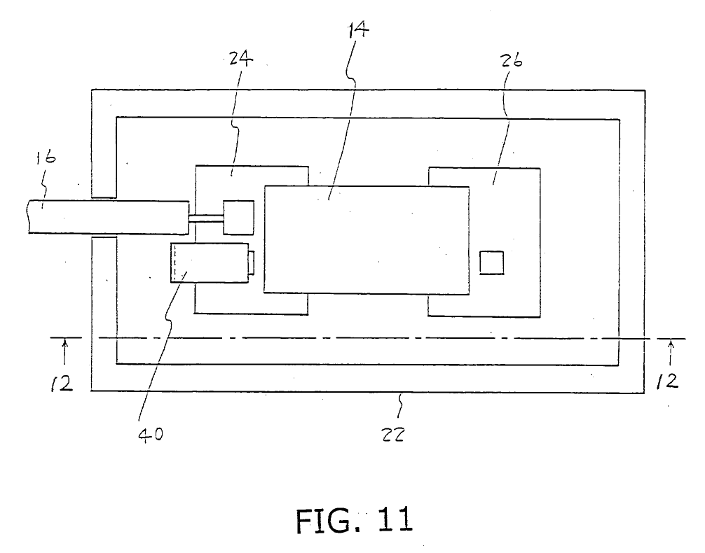

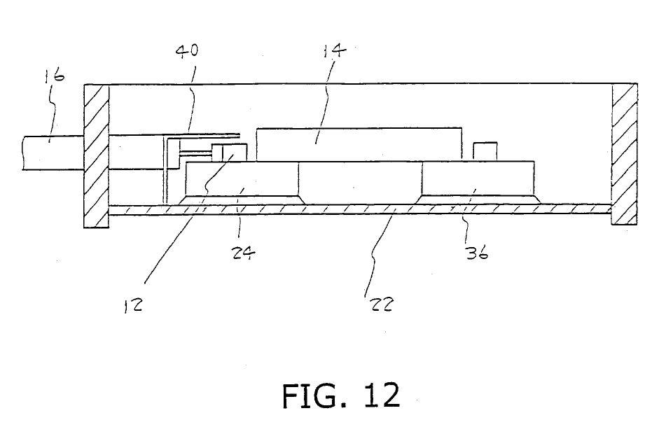

In FIGS. 11 and 12, the optical transmitter/receiver module with the electrical noise preventive measure according to the sixth embodiment comprises an L-shaped metal plate, such as a metal plate 4.0 made of a Copper-Nickel alloy and having a width of approximately 2.35 mm, which is bonded on the interior bottom of the package 22 in the vicinity of the optical transmitter section 12 such that an end of the metal plate 40 covers the upper surface of the optical transmitter section 12 in the silicon substrate 24. The metal plate 40 is connected to the ground portion (GND) provided on the interior bottom of the package 22. According to the sixth embodiment, the same effects as those in the fifth embodiment are obtained because the major part of electromagnetic wave emitted from the optical transmitter section 12 is shielded by the metal plate 40.

According to the seventh embodiment, the metal plate 38 is bonded on the interior bottom of the package 22 in the vicinity of the optical receiver section 18 such that an end of the metal plate 38 covers over the upper surface of the optical receiver section 18 in the silicon substrate 26 in the same way as in the fifth embodiment, and the metal plate 40 is bonded on the interior bottom of the package 22 in the vicinity of the optical transmitter section 12 such that the end of the metal plate 40 covers over the upper surface of the optical transmitter section 12 in the silicon substrate 24 in the same way as in the sixth embodiment. The metal plates 38 and 40 are connected to the ground portion (GND) provided on the interior bottom of the package 22. According to the seventh embodiment, at least the same-level of effects as those in the fifth and sixth embodiments are obtained because the major part of electromagnetic wave which is emitted from the optical transmitter section 12 and input to the optical receiver section 18 is shielded by the metal plates 40 and 38, respectively.

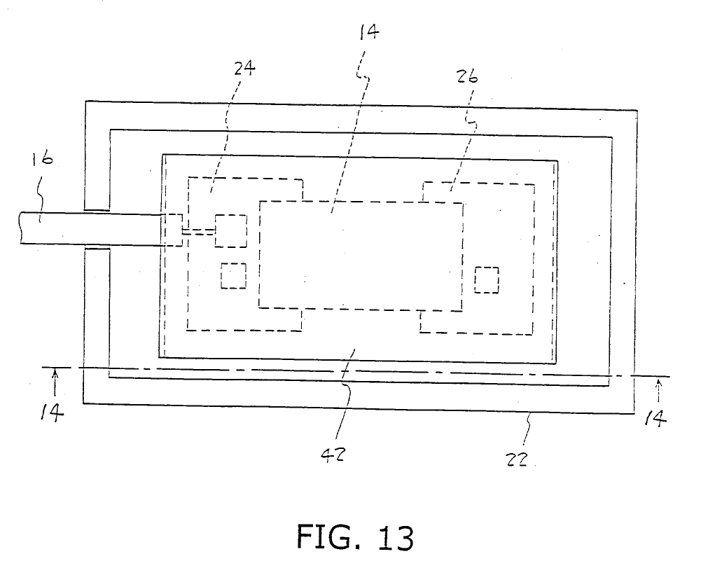

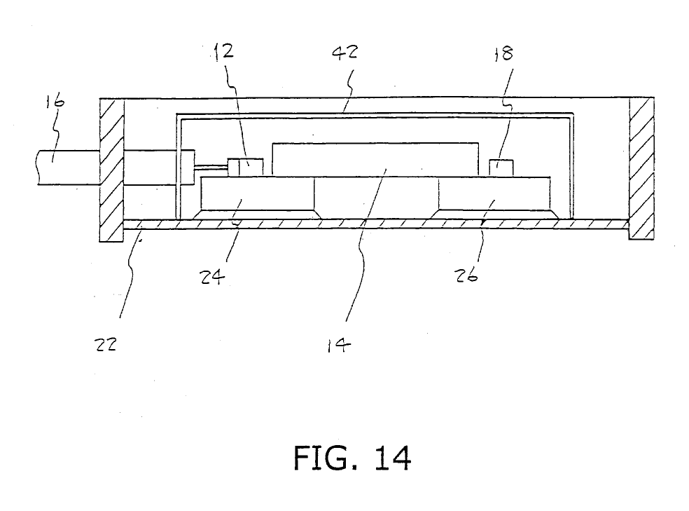

In FIGS. 13 and 14, the optical transmitter/receiver module with the electrical noise preventive measure according to the eighth embodiment comprises a metal plate 42 made of a Copper-Nickel alloy and having a width of approximately 2.35 mm. Both ends of the metal plate 42 are bent in the same direction so as to be bonded to the interior bottom of the package 22 such that the metal plate 42 covers the upper surfaces of the optical transmitter section 12, the WDM optical circuit 14, and the optical receiver section 18. Both the ends of the metal plate 40 are connected to the ground portion (GND) provided on the interior bottom of the package 22. According to the eighth embodiment, the same effects as those in the fifth or sixth embodiment- are obtained because electromagnetic wave transmitted from the optical transmitter section 12 to the optical receiver section 18 is attenuated by the metal plate 40.

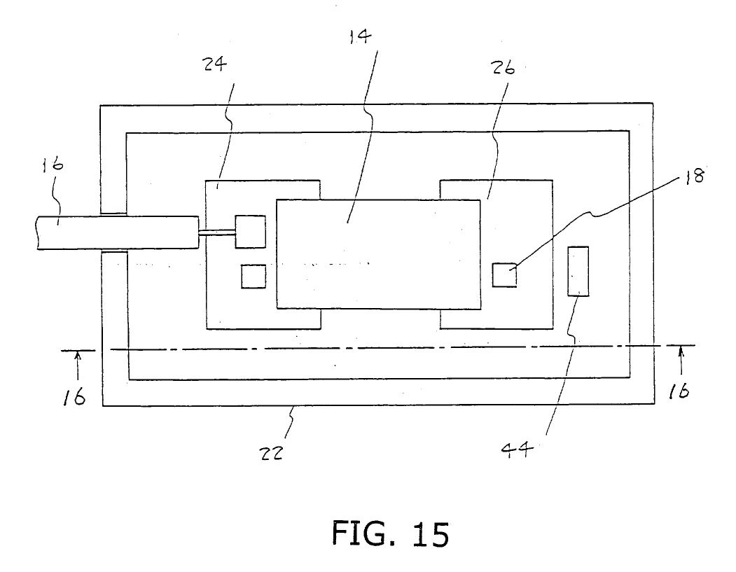

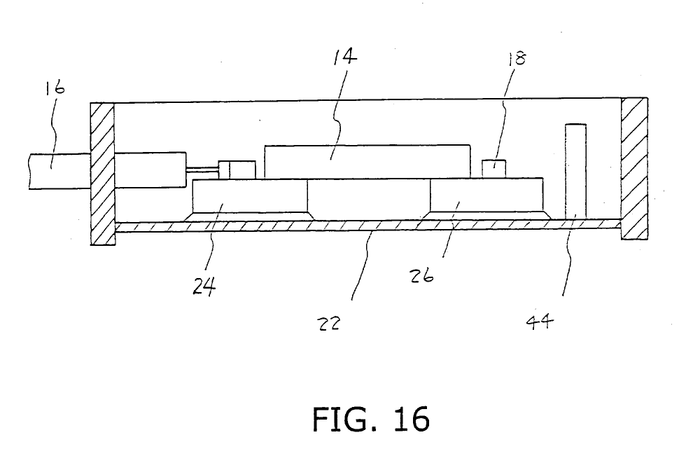

In FIGS. 15 and 16, the optical transmitter/receiver module with the electrical noise preventive measure according to the ninth embodiment comprises an electromagnetic wave absorbing plate 44 which is bonded on the interior bottom of the package 22 in the vicinity of the optical receiver section 18 so as to absorb electromagnetic wave. According to the ninth embodiment, the same effects as those in the first embodiment are obtained because the major part of electromagnetic wave input to the optical receiver section 18 is absorbed by the absorbing plate 44 so that the electrical noise caused in the optical receiver section 18 is reduced.

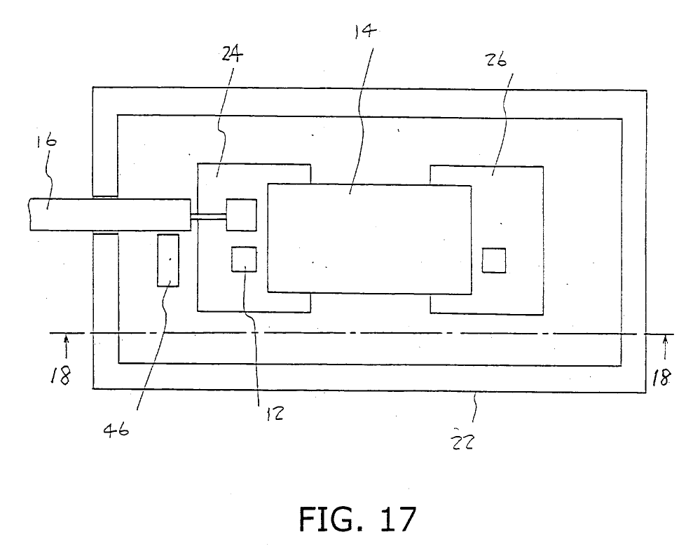

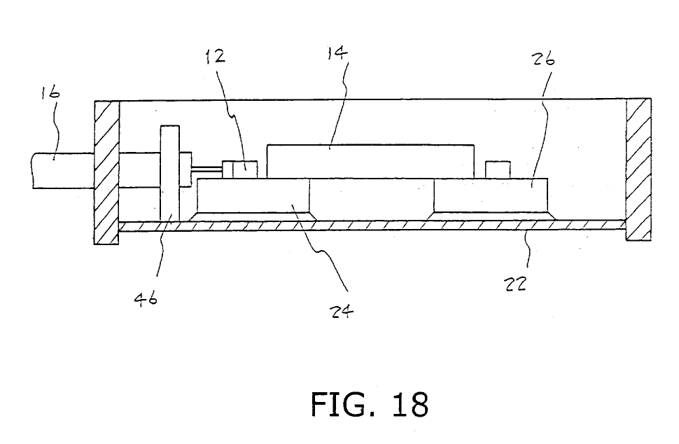

In FIGS. 17 and 18, the optical transmitter/receiver module with the electrical noise preventive measure according to the tenth embodiment comprises an electromagnetic wave absorbing plate 46 which is bonded on the interior bottom of the package 22 in the vicinity of the optical transmitter section 12 so as to absorb electromagnetic wave. According to the tenth embodiment, the same effects as those in the ninth embodiment are obtained because the major part of electromagnetic wave transmitted from the optical transmitter section 12 is absorbed by the absorbing plate 46 so that the electrical noise caused in the optical receiver section 18 is reduced.

According to the eleventh embodiment, the electromagnetic wave absorbing plate 44 is bonded on the interior bottom of the package 22 in the vicinity of the optical receiver section 18 in the same way as in the ninth embodiment, and the electromagnetic wave absorbing plate 46 is bonded on the interior bottom of the package 22 in the vicinity of the optical transmitter section 12 in the same way as in the tenth embodiment. According to the eleventh embodiment, the same effects as those in the ninth or tenth embodiment are obtained because the major part of electromagnetic wave which is emitted from the optical transmitter section 12 and input to the optical receiver section 18 is absorbed by the absorbing metal plates 46 and 44, respectively.

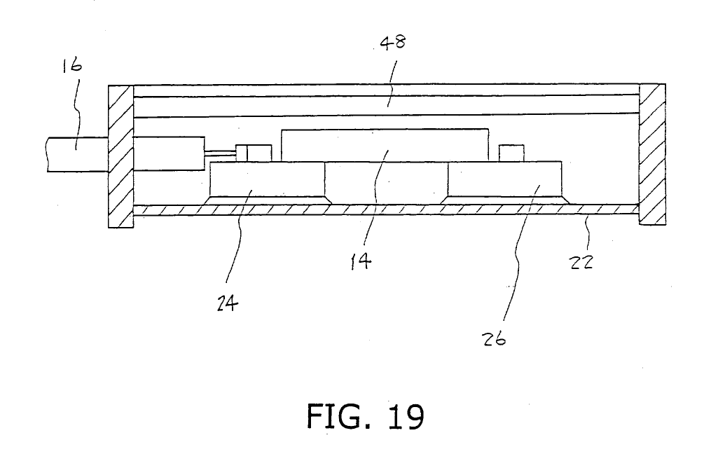

In FIG. 19, the optical transmitter/receiver module with the electrical noise preventive measure according to the twelfth embodiment comprises an electromagnetic wave absorbing plate 48, which is bonded to the upper part of the inside wall of the package 22 and caps the package 22 so that the optical transmitter and receiver sections 12 and 18, and the WDM optical circuit 14 are covered by the absorbing plate 48. According to the twelfth embodiment, the same effects as those in the ninth embodiment are obtained because electromagnetic wave which is emitted from the optical transmitter'section 12 to the optical receiver section 18 is absorbed by the absorbing metal plates 48 and the electrical noise caused in the optical receiver section 18 is reduced.

As has been described above, according to the invention, the electromagnetic wave, which is emitted from the optical transmitter section, transmitted from the optical transmitter section to the optical receiver section, or input to the optical receiver section, is decreased by the metal wire, metal plate, or electromagnetic wave absorbing plate so that the electrical noise which is produced in the optical receiver section is reduced and the minimum photo detective sensitivity is increased.

1. An optical transmitter/receiver module, comprising:
an insulative package;
an optical transmitter section provided in said insulative package and having an optical source to convert an electrical signal to an optical signal;
an optical receiver section provided in said insulative package and having an optical detector to convert said optical signal to said electrical signal; and
a shielding member for shielding electromagnetic wave between said optical transmitter and receiver sections.

2. The optical transmitter/receiver module according to claim 1, wherein said shielding member is a metal wire provided over said optical transmitter or receiver section and having ends fixed to opposite inside walls of said insulative package and connected to a ground portion of said package.

3. The optical transmitter/receiver module according to claim 2, wherein said metal wire is made of gold and having a diameter of 25 μm.

4. The optical transmitter/receiver module according to claim 2, which further comprises a wavelength division multiplex (WDM) optical circuit provided in said package.

5. The optical transmitter/receiver module according to claim 1, wherein said shielding member is a pair of metal wires, one of said metal wires being provided over said optical transmitter section and having ends fixed to opposite inside walls of said package and connected to a ground portion of said package and the other of said metal wires being provided over said optical receiver section and having ends fixed to said opposite inside walls of said package and connected to said ground portion of said package.

6. The optical transmitter/receiver module according to claim 5, wherein said metal wires are made of gold and having a diameter of 25 μm.

7. The optical transmitter/receiver module according to claim 5, which further comprises a wavelength division multiplex (WDM) optical circuit provided in said package.

8. The optical transmitter/receiver module according to claim 1, wherein said shielding member is a plurality of metal wires provided in parallel to each other at a predetermined interval such that they pass over said optical transmitter and receiver sections, each of said metal wires having ends fixed to opposite inside walls of said package and connected to a ground portion of said package.

9. The optical transmitter/receiver module according to claim 8, wherein said metal wires are made of gold and having a diameter of 25 μm.

10. The optical transmitter/receiver module according to claim 8, which further comprises a wavelength division multiplex (WDM) optical circuit provided in said package such that said metal wires pass over said WDM optical circuit.

11. The optical transmitter/receiver module according to claim 1, wherein said shielding member is a metal plate covering said optical transmitter or receiver section and having an end fixed to an inside bottom of said package and connected to a ground portion of said package.

12. The optical transmitter/receiver module according to claim 11, wherein said metal plate is made of Copper-Nickel alloy and having a width of 2.35 mm.

13. The optical transmitter/receiver module according to claim 11, which further comprises a wavelength division multiplex (WDM) optical circuit provided in said package.

14. The optical transmitter/receiver module according to claim 1, wherein said shielding member is a pair of metal plates, one of said metal plates covering said optical transmitter section and having an end fixed to an inside bottom of said package and connected to a ground portion of said package and the other of said plates covering said optical receiver section and having an end fixed to said inside bottom of said package and connected to said ground portion of said package.

15. The optical transmitter/receiver module according to claim 14, wherein said metal plates are made of Copper-Nickel alloy and having a width of 2.35 mm.

16. The optical transmitter/receiver module according to claim 14, which further comprises a wavelength division multiplex (WDM) optical circuit provided in said package.

17. the optical transmitter/receiver module according to claim 1, wherein said shielding member is a metal plate covering said optical transmitter and receiver sections and having ends bent in the same direction so as to be fixed to an inside bottom of said package and connected to a ground portion of said package.

18. The optical transmitter/receiver module according to claim 17, wherein said metal plate is made of Copper-Nickel alloy and having a width of 2.35 mm.

19. The optical transmitter/receiver module according to claim 17, which further comprises a wavelength division multiplex (WDM) optical circuit provided in said package such that said metal plate covers over said WDM optical circuit.

20. the optical transmitter/receiver module according to claim 1, wherein said shielding member is an electromagnetic wave absorbing member provided in the vicinity of said optical transmitter section or said optical receiver section and having an end fixed to an inside bottom of said package.

21. the optical transmitter/receiver module according to claim 1, wherein said shielding member is a pair of electromagnetic wave absorbing members, one of said electromagnetic wave absorbing member being provided in the vicinity of said optical transmitter section and having an end fixed to an inside bottom of said package and the other of electromagnetic wave absorbing member being provided in the vicinity of said optical receiver section and having an end fixed to an inside bottom of said package.

22. The optical transmitter/receiver module according to claim 1, wherein said shielding member is an electromagnetic wave absorbing member provided in said package so as to cover said optical transmitter and receiver sections.
